(19) United States
(12) Patent Application Publication
(10) Pub. No.: US 2009/0063241 A1
(43) Pub. Date: Mar. 5, 2009

(54) Demand Driven Scheduling

(75) Inventors: Alexander Nathan Wilkes, Chicago, IL (US); David Cutler, Oak Park, IL (US); Angela Dawn Evans, Arlington, TX (US); Jeff Berg, Minneapolis, MN (US)

Correspondence Address: William J. Klein;Banner & Witcoff, Ltd., Ten South Wacker Drive, Chicago, IL, 60606-7407, US

(73) Assignee: ACCENTURE GLOBAL SERVICES GMBH

(21) Appl. No.: 11/848,666

(22) Filed: Aug. 31, 2007

(51) Int. Cl. G06Q 10/00

(52) U.S. Cl. 705/9; 718/104

(57) ABSTRACT

Scheduling of service calls for field service workers may be optimized based, at least in part, upon market demand for field service visits, in accordance with various embodiments of the invention. During relatively higher demand periods, schedules for field service workers may be optimized to be relatively compact such that relatively more appointments are placed on a given schedule. During relatively lower demand periods, schedules may be optimized such that relatively more time will be provided between appointments to allow for more up-selling opportunities during service visits. Such scheduling optimizations are referred to herein as demand driven scheduling because how a field service worker's schedule is optimized is determined based, at least in part, on market demand for service calls in a particular geographic region during a given period of time.

### FIELD OF THE INVENTION

Aspects of the invention relate generally to scheduling of field service visits. More specifically, aspects of the invention are directed to using demand driven scheduling policies for optimizing schedules for field service workers.

### BACKGROUND OF THE INVENTION

Optimization of schedules for field service personnel typically follows a model in which field service jobs (e.g., appliance repair, utility, telephone, or cable television service visits) are scheduled as closely together as possible to optimize the number of jobs that can be performed by a given number of field service workers during a given period of time.

FIG. 1 shows an example of optimizing a schedule for a field service worker in accordance with the prior art. As shown in FIG. 1, the non-optimized commute times between jobs 1 and 2 and between jobs 2 and 3 are optimized thereby leaving a gap at the end of the field service worker's schedule. Such an optimization model provides little, if any, optimization of revenue from a field service work force assuming an unchanged market demand (i.e., there is not enough market demand to generate a fourth job) and an unchanged number of field service workers (i.e., demand per worker is not increased by decreasing the number of workers).

Techniques for scheduling field service jobs such that revenue is potentially increased during low demand conditions would advance the art.

### BRIEF SUMMARY OF THE INVENTION

The following presents a simplified summary of the invention in order to provide a basic understanding of some aspects of the invention. This summary is not an extensive overview of the invention. It is not intended to identify key or critical elements of the invention or to delineate the scope of the invention. The following summary merely presents some concepts of the invention in a simplified form as a prelude to the more detailed description provided below.

To overcome limitations in the prior art described above, and to overcome other limitations that will be apparent upon reading and understanding the present specification, embodiments of the invention are directed to optimizing scheduling of service calls for field service workers based, at least in part, upon market demand for field service visits. During relatively higher demand periods, schedules for field service workers may be optimized to be relatively compact such that relatively more appointments are placed on a given schedule. During relatively lower demand periods, schedules may be optimized such that relatively more time will be provided between appointments to allow for more up-selling opportunities during service visits. Such scheduling optimizations are referred to herein as demand driven scheduling because how a field service worker's schedule is optimized is determined based, at least in part, on market demand for service calls in a particular geographic region during a given period of time.

### BRIEF DESCRIPTION OF THE DRAWINGS

A more complete understanding of the present invention and the advantages thereof may be acquired by referring to the following description in consideration of the accompanying drawings, in which like reference numbers indicate like features, and wherein:

FIG. 1 shows an example of optimizing a schedule for a field service worker in accordance with the prior art.

FIG. 2 is a schematic diagram showing how scheduling of service calls for field service workers may be optimized based, at least in part, upon market demand for field service visits, in accordance with various embodiments of the invention.

FIG. 3 is a schematic diagram of a computer system in which various aspects of the invention may be embodied.

FIG. 4 is a schematic diagram of a system for performing demand driven scheduling in accordance with various embodiments of the invention.

FIG. 5 is a flow diagram of steps for scheduling a field service visit in accordance with embodiments of the invention.

FIG. 6 is a flow diagram of steps for using demand driven scheduling policies for scheduling a field service visit in accordance with embodiments of the invention.

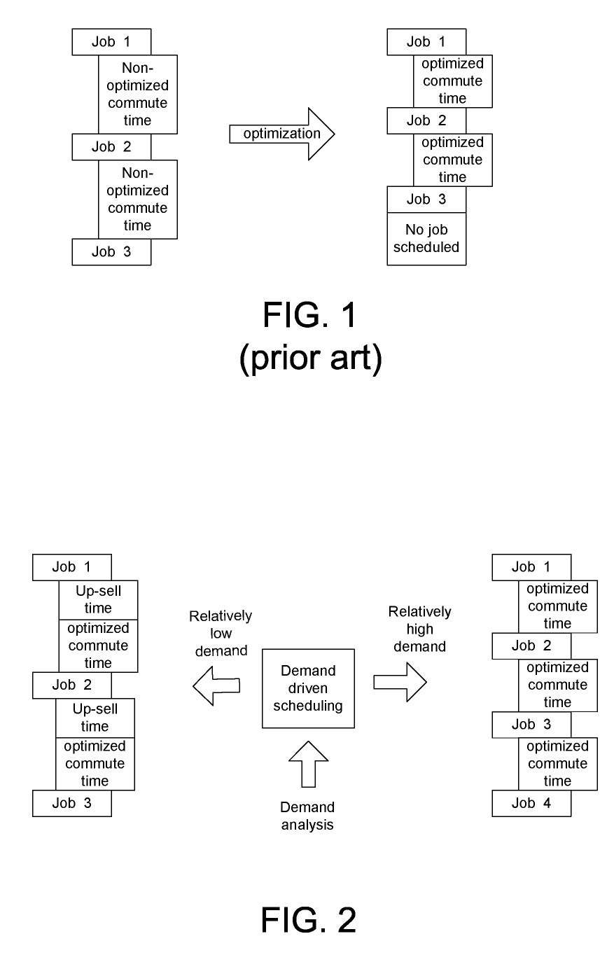

### DETAILED DESCRIPTION OF THE INVENTION

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope of the present invention.

In accordance with various illustrative embodiments of the invention, demand driven scheduling policies potentially increase revenue from a field service workforce under variable market demand conditions. FIG. 2 is a schematic diagram showing how scheduling of service calls for field service workers may be optimized based, at least in part, upon market demand for field service visits, in accordance with various embodiments of the invention. During relatively higher demand periods, schedules for field service workers may be optimized to be relatively compact such that relatively more appointments are placed on a given schedule. During relatively lower demand periods, schedules may be optimized such that relatively more time will be provided between appointments to allow for more up-selling opportunities during service visits. Such scheduling optimizations are referred to herein as demand driven scheduling because how a field service worker's schedule is optimized is determined based, at least in part, on market demand for service calls in a particular geographic region during a given period of time.

Demand driven scheduling policies may be applied to a relatively broader group of field service workers and/or to a relatively narrower group of field service workers thereby allowing for regional variances in demand or to account for short-term over or under staffing.

During periods of low demand and/or over staffing, field service workers are typically under utilized. Revenue may be increased in accordance with embodiments of the invention by padding scheduled jobs with “up-sell” time thereby allowing field service workers to sell customers add-on services. For example, if the field service worker is on a service visit to install a wireless network in someone's house, the field service worker may use the up-selling time to offer additional services such as removing viruses and/or spyware from one or more of the customer's computers during the service visit. In this way, otherwise idle (i.e., non-scheduled) time may be replaced with an opportunity to generate revenue through add on sales, which are often the most profitable because there is no cost associated with dispatching the field service worker.

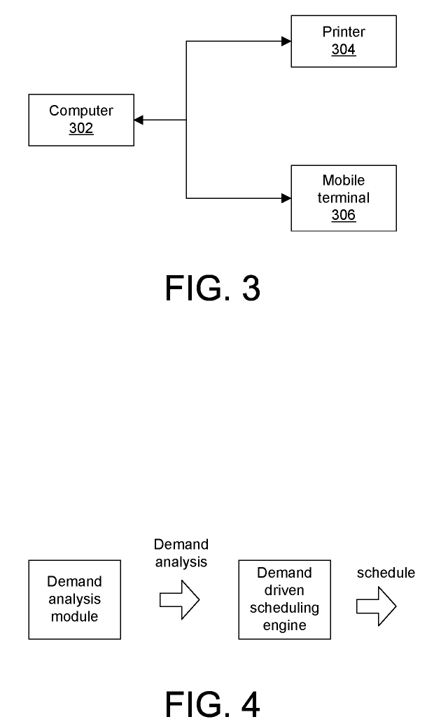

FIG. 3 is a schematic diagram of a computer system in which various aspects of the invention may be embodied. A computer 302 may include a central processor that controls the overall operation of the computer and a system bus that connects central processor to components described below. The system bus may be implemented with any one of a variety of conventional bus architectures. The computer may include a variety of interface units and drives for reading and writing data or files from and to various types of computer readable media. A user may interact with the computer via a variety of input devices, including, but not limited to, a keyboard and a pointing device. The computer may include a video adapter coupling a display device to the system bus. The display device may be used for producing an image that is viewable by the user. Sound can be recorded and reproduced with a microphone and a speaker. Operation of the computer may be controlled by computer-executable instructions stored on a computer-readable medium. For example, the computer may include computer-executable instructions for displaying information on a display device.

The computer 302 may be coupled to a printer 304 for printing hard copies of schedules for field service workers. The computer may also communicate with one or more mobile terminals 306 for wirelessly transmitting a field service worker's schedule to the mobile terminal for display to a field service worker. A mobile terminal may be a portable computing device, including, but not limited to, a laptop computer, a personal digital assistant, a cellular telephone, and the like.

FIG. 4 is a schematic diagram of a system for performing demand driven scheduling in accordance with various embodiments of the invention. As shown in FIG. 4, a demand driven scheduling engine receives demand analysis information from a demand analysis module. The demand analysis module may make a determination with respect to whether demand is relatively low or relatively high for a particular geographic market during a given time period. Such a determination (i.e., relatively low demand versus relatively high demand) may be made by considering factors including, but not limited to: a number of jobs scheduled during a given time period, a number of available field service workers, one or more thresholds for field service worker utilization (e.g., thee or fewer jobs per day per worker is low demand, while four or more jobs per day is high demand), and the like. As will be apparent, other suitable thresholds may also be used.

In accordance with an embodiment of the invention, a replenishment system, such as a replenishment system available from Manugistics, JDA, or SAP may be used for distinguishing between low and high demand conditions. Replenishment systems of this type may be used for forecasting how many service visits are expected to be scheduled during a given time period.

In accordance with embodiments of the invention, it is possible to have one or more additional demand analysis ratings. For example, low, medium, and high market demand conditions could each be handled differently. For example, less up-sell time could be added to service visits scheduled to occur during medium market demand conditions than an amount of up-sell time added to service visits scheduled to occur during low market demand conditions. As will be apparent, any other suitable number of different market demand analysis conditions may also be used.

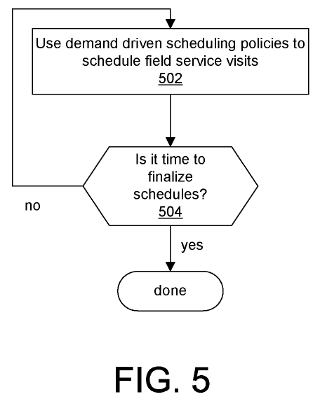

FIG. 5 is a flow diagram of steps for scheduling a field service visit in accordance with embodiments of the invention. Demand driven scheduling policies are used to schedule field service visits, as shown at 502, until a determination is made at 504 that schedules for field service visits should be finalized for a particular time period (e.g., a day, a week, or the like). Such a determination may be made a predetermined amount of time before the time period for which field service visits are being scheduled. For example, such a determination may be made at midnight the day before the scheduled day of the field service visits.

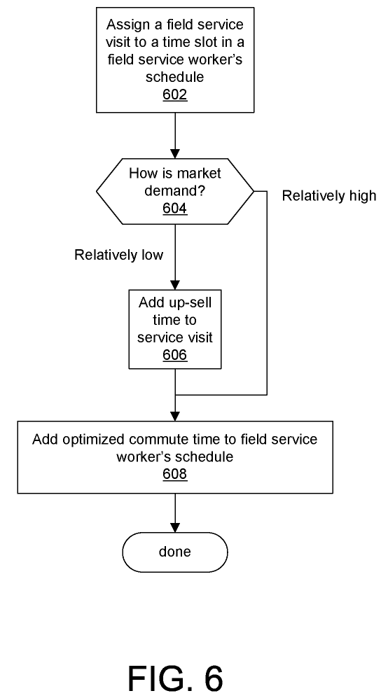

FIG. 6 is a flow diagram of steps for using demand driven scheduling policies for scheduling a field service visit in accordance with embodiments of the invention. A field service visit is assigned to a time slot in a field service worker's schedule, as shown at 602. Assignment of particular field service visits to particular field service workers may be based on various criteria including, but not limited to: geographic proximity of service visits being scheduled, the respective skill levels of various field service workers, and the like.

As shown at 604, a determination is made with respect to market demand applicable to the field service visit scheduled at 602. If market demand is relatively low for the scheduled field service visit, then up-sell time is added to the scheduled service visit, as shown at 606. Otherwise, market demand is relatively high for the scheduled field service visit, so up-sell time is not added to the scheduled service visit. An optimized commute time is then added to the field service worker's schedule following the scheduled field service visit (and the up-sell time when market demand is relatively low), as shown at 608.

In accordance with various embodiments of the invention, market demand assessment and scheduling of up-selling opportunities may be performed once it is time to finalize schedules and the “yes” branch from 504 is followed.

One or more aspects of the invention may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, RAM, etc. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like.

Embodiments of the invention include any novel feature or combination of features disclosed herein either explicitly or any generalization thereof. For example, various embodiments of the invention may be implemented in conjunction with a conventional scheduling system, such as, Click Software or Indus. Any of the method steps disclosed herein can be implemented in computer software, hardware, or combinations thereof, and may be embodied on computer-readable media. Functions for selecting, forming, transmitting, receiving, processing, and displaying can be carried out using one or more processors and/or other chipsets programmed to carry out the respective functions. While the invention has been described with respect to specific examples including presently preferred modes of carrying out the invention, those skilled in the art will appreciate that there are numerous variations and permutations of the above described systems and techniques. Thus, the spirit and scope of the invention should be construed broadly as set forth in the appended claims.

We claim:

1. A system for scheduling field service visits, the system comprising:
a demand analysis module that generates demand analysis data;
a demand driven scheduling engine that generates schedules for field service workers such that up-sell time is added to field service visits scheduled during times for which the demand analysis data indicates that market demand for field service visits is relatively low.

2. The system of claim 1, wherein the demand analysis data indicates whether market demand is relatively high or relatively low for a particular geographic market during a given time period.

3. The system of claim 2, wherein the demand analysis data specifies one or more demand analysis ratings in addition to relatively high market demand and relatively low market demand.

4. The system of claim 1, wherein the demand analysis data is based on a number of jobs scheduled during a given time period.

5. The system of claim 1, wherein the demand analysis data is based on a number of available field service workers.

6. The system of claim 1, wherein the demand analysis data is based on a threshold for field service worker utilization.

7. The system of claim 1, wherein the demand analysis module further comprises a replenishment system.

8. A method of scheduling a field service visit, the method comprising:
assigning the field service visit to a time slot in a field service worker's schedule;
determining whether market demand is relatively low during the time slot; and
if market demand is relatively low during the time slot, adding up-sell time to the field service visit.

9. The method of claim 9, wherein the determining step is based on a number of jobs scheduled during a given time period.

10. The method of claim 9, wherein the determining step is based on a number of available field service workers.

11. The method of claim 9, wherein the determining step is based on a threshold for field service worker utilization.

12. The method of claim 9, further comprising: adding optimized commute time to the field service worker's schedule following the field service visit.

13. The method of claim 9, further comprising: printing a copy of the field service worker's schedule.

14. The method of claim 9, further comprising: transmitting the field service workers schedule to a mobile terminal.

15. The method of claim 14, further comprising: displaying the schedule on the mobile terminal's display screen.

16. An apparatus having a computer readable medium that contains computer executable instructions for causing the apparatus to perform operations comprising:
assigning the field service visit to a time slot in a field service worker's schedule;
determining whether market demand is relatively low during the time slot; and
if market demand is relatively low during the time slot, adding up-sell time to the field service visit.

17. The apparatus of claim 16, wherein the determining operation is based on a number of jobs scheduled during a given time period.

18. The apparatus of claim 16, wherein the determining step is based on a number of available field service workers.

19. The apparatus of claim 16, wherein the determining step is based on a threshold for field service worker utilization.

20. The apparatus of claim 16, wherein the computer-readable medium contains further computer-executable instructions for causing the apparatus to perform further operations comprising: adding optimized commute time to the field service worker's schedule following the field service visit.
